(19) United States
(12) Patent Application Publication
(10) Pub. No.: US 2018/0313471 A1
(43) Pub. Date: Nov. 1, 2018

(54) COMPOSITE PIPE COMPRISED OF A CARRIER PIPE AND AT LEAST ONE PROTECTIVE PIPE, AND METHOD FOR THE PRODUCTION THEREOF

(71) Applicant: Salzgitter Flachstahl GmbH, Salzgitter (DE)

(72) Inventors: MARC DEBEAUX, Hildesheim (DE); PETER PALZER, Liebenburg (DE); KAI KÖHLER, Nordstemmen (DE); ZACHARIAS GEORGEOU, Braunschwelg (DE)

(73) Assignee: Salzgitter Flachstahl GmbH, Salzgitter (DE)

(21) Appl. No.: 15/770,428

(22) PCT Filed: Oct. 19, 2016
(86) PCT No.: PCT/EP2016/075137

§ 371 Date: Apr. 23, 2018

(30) Foreign Application Priority Data
Oct. 21, 2015 (DE) 10 2015 117 956.3

(51) Int. Cl. F16L 9/18; B21C 37/15; B21D 26/051; B21D 26/053; B32B 1/08; B32B 15/01; C22C 38/04; C22C 38/08; C22C 38/34; C22C 38/38; C22C 38/58; F16L 58/08

(52) U.S. Cl. CPC F16L 9/18; B21C 37/154; B21D 26/051; B21D 26/053; B32B 1/08; B32B 15/011; F16L 58/08; C22C 38/04; C22C 38/08; C22C 38/34; C22C 38/38; C22C 38/58; B32B 15/015

(57) ABSTRACT

A composite pipe includes a carrier pipe and at least one protective pipe. The carrier pipe is produced from a non-corrosion resistant steel, which has at least a partially austenitic structure, with the following chemical composition (in wt. %): C: 0.005 to 1.4; Mn: 5 to 35; the remainder being iron including unavoidable elements accompanying steel, with the optional alloying of the following elements (in wt. %): Ni: 0 to 6; Cr: 0 to 9; Al: 0 to 15; Si: 0 to 8; Mo: 0 to 3; Cu: 0 to 4; V: 0 to 2; Nb: 0 to 2; Ti: 0 to 2; Sb: 0 to 0.5; B: 0 to 0.5; Co: 0 to 5; W: 0 to 3; Zr: 0 to 4; Ca: 0 to 0.1; P: to 0.6; S: 0 to 0.2; N: 0.002 to 0.3. In a method for producing a composite pipe of this type, the carrier pipe and the at least one protective pipe are mechanically or metallurgically connected to one another.

The invention relates to a composite pipe comprised of a carrier pipe and at least one protective pipe, wherein the carrier pipe is produced from a non-corrosion-resistant steel. The invention also relates to a method for producing a composite pipe comprised of a carrier pipe and at least one protective pipe.

It is generally known that plated pipes are composite components in which, by a combination of different materials, it is possible to achieve advantages of a technical and economic nature. A conventional combination is comprised of plating materials with good wear-resistance and/or corrosion-resistance properties and materials for the base or carrier pipe with good mechanical properties. These composite components are rendered economical by reducing the thickness of the plating materials, which are mostly very expensive, to the extent technically required for the respective purpose and the composite pipe is rendered stable by using the most favourable material for the base or carrier pipe.

The German laid-open document DE 30 39 428 A1 already discloses a method for producing plated steel pipes which include a base wall and an outer and/or inner wall. Depending on the construction of the steel pipe in a two-walled or three-walled form, the base wall can serve as an inner, outer or intermediate wall. Such multi-walled steel pipes are conventionally used in corrosive or abrasive environments and can be produced economically since only the wall or walls which come into contact with the corrosive or abrasive media are produced from a correspondingly expensive corrosion-resistant protective metal. Protective metals can be abrasion-resistant steel (carbon-rich abrasion-resistant steel and abrasion-resistant manganese steel), rust-proof steel, nickel, nickel alloys, titanium, titanium alloys, copper, copper alloys, chromium, chromium alloys, aluminium and aluminium alloys. Base metals for the base wall are carbon steel, alloy steel, rust-proof steel (martensitic steel, austenitic steel, precipitation-hardened steel and rust-proof chromium-manganese steel) and nickel alloys. For the production of a plated steel pipe with an inner wall of corrosion-resistant protective metal an inner pipe of protective metal is inserted into a base pipe of a base metal. The inner diameter of the base pipe and the outer diameter of the inner pipe are selected in such a way that the inner pipe can be inserted. The outer surface of the inner pipe and the inner surface of the outer pipe are cleaned prior to this, e.g. by polishing or an acid wash. The inner pipe and the outer pipe are then mechanically connected to one another via a reduction and one-stage or multi-stage cold-drawing on a cold-drawing bench. The cold-drawn pipe is then heated in a pre-heating oven and hot-rolled and then possibly cold-rolled to form an end pipe. The hot rolling produces a metallurgical connection of the inner and outer pipe. In order to avoid penetration of air between the inner pipe and the outer pipe, build-up welding is preferably carried out at the end faces of the cold-drawn pipe. When the inner pipe has a higher thermal expansion coefficient than the outer pipe it is possible to omit build-up welding. This is the case when the inner pipe is made of carbon steel and the outer pipe is made of ferritic rust-proof steel.

Furthermore, European patent EP 0 944 443 B1 already describes a method for producing internally plated pipes with an outer pipe and an inner pipe. The pipes are provided for the transportation of corrosive and/or abrasive fluids. In relation to this, the outer pipe is made of a carbon steel or another higher-strength metallic material, in particular a martensitic chromium steel, a duplex steel or an austenitic high-grade steel. The inner pipe is produced from a corrosion-resistant and/or wear-resistant metallic material, in particular a martensitic chromium steel, a duplex steel or a ferritic or austenitic high-grade steel, titanium, a titanium alloy or a nickel-based alloy. Between the outer pipe and the inner pipe a non-positive assemblage is created in terms of a press-fit by mechanical shrinkage, wherein the diameter of the outer pipe is reduced. For this purpose, the outer pipe is forced through a reducing ring along with the inner pipe. In particular, in relation to this, the outer pipe is reduced only to such an extent that the mechanical deformation of the inner pipe brought about in this way remains within the elastic range.

This European patent also describes different known methods for connecting an inner pipe and an outer pipe to one another to form a composite pipe. A distinction is fundamentally made between a mechanical connection—so-called rattle-free connections—and a metallurgical connection. Composite pipes with a metallurgical connection are produced by hot forming, e.g. by co-extrusion, roll plating, hot isostatic pressing, explosive plating or weld plating. In relation to this, it can be disadvantageous that any required heat treatment cannot be tailored optimally to both materials of the composite pipe. Composite pipes with a mechanical connection are produced e.g. by hydraulic widening of the inner pipe with or without simultaneous heating of the outer pipe, widening of the inner pipe with a drawing plug or by the previously described reduction of the outer pipe through a drawing ring. The production of composite pipes by means of a mechanical connection usually involves lower production costs than the production of composite pipes by means of metallurgical connection. In the case of composite pipes by means of mechanical connection it should be ensured that no moisture, which could lead to corrosion, penetrates into the zone between the inner and outer pipe.

The previously known solutions have the disadvantage that by reason of the selected starting materials only base pipes or carrier pipes with a limited formability are produced or high-alloy steels with high Cr and/or Ni proportions have to be used for improved formability, which involves higher costs.

On this basis, the object of the present invention is to create a further composite pipe for use in a corrosive environment, comprised of a carrier pipe and at least one protective pipe, and a further method for producing this composite pipe, which is characterised in particular by low production costs.

This object is achieved by an composite pipe having the features of claim 1 and a method for the production thereof according to claim 29. Advantageous embodiments of the invention are given in dependent claims 2 to 28 and 30.

In accordance with the invention a further composite pipe includes a carrier pipe and at least one protective pipe, wherein the carrier pipe is produced from a non-corrosion-resistant steel which comprises at least one part-austenitic microstructure, is created in that the steel of the carrier pipe with the following chemical composition (in wt. %) comprises: C: 0.005 to 1.4; Mn: 5 to 35; with the remainder being iron including unavoidable, steel-associated elements, with optional addition by alloying of the following elements (in wt. %): Ni: 0 to 6; Cr: 0 to 9; Al: 0 to 15; Si: 0 to 8; Mo: 0 to 3; Cu: 0 to 4; V: 0 to 2; Nb: 0 to 2; Ti: 0 to 2; Sb: 0 to 0.5; B: 0 to 0.5; Co: 0 to 5; W: 0 to 3; Zr: 0 to 4; Ca: 0 to 0.1; P: 0 to 0.6; S: 0 to 0.2; N: 0.002 to 0.3.

In an advantageous manner, the steel of the carrier pipe comprises the known temperature-dependent TRIP (Transformation Induced Plasticity)—or TWIP (Twinning Induced Plasticity)—effect which permits an enormous increase in the cold-formability of the steel during forming of the pipe. These effects occur in high-alloy at least part-austenitic steels or steels having a high manganese content and during plastic deformation of the steel are characterised by the formation of deformation martensite (TRIP effect) or by twinning during deformation (TWIP effect). Such TRIP and TWIP steels and steels with a multiphase microstructure comprise excellent combination of strength, expansion and toughness properties. During pipe forming (e.g. by pipe drawing or internal high-pressure forming) the TRIP and/or TWIP effect causes solidification of the carrier pipe to take place while the formability is improved at the same time. The increase in strength allows the pipe to have thinner walls, whereby material and costs are saved.

The carrier pipe is preferably produced from a steel with a microstructure with an austenite content of 5 to 100%.

The present invention is based on the idea of producing composite pipes with carrier pipes based on steels with a higher manganese content, preferably with the addition of aluminium and silicon which are not corrosion-resistant. The microstructure of these steels is at least part-austenitic and is characterised particularly by a high level of strength while at the same time being very expandable and tough. Such steels can be produced using a strip casting process, amongst others. The thickness of the carrier pipe can be reduced by having the very high achievable strength levels, whereby resources can be saved and the ecological footprint can be improved and the potential for light-weight construction is rendered possible. Furthermore, the addition by alloying of aluminium and silicon reduces the relative density and thereby renders possible additional potential for light-weight construction.

Such carrier pipes form an excellent basis for composite pipes which, in terms of plated pipes can be used for conveying corrosive media and/or for use under corrosive conditions. These composite pipes can be used under severe mechanical stress (tension forces, pressure loading, bending loading etc.) and in particular also in the low temperature range.

The composite pipe preferably has a mechanical connection between the carrier pipe and the protective pipe or the protective pipes.

The protective pipes are preferably produced from a corrosion-resistant or corrosion-passive steel (in particular CrNi, CrMn, CrMnNi, CrMnN, FeCr, AlCroMaSt) or a nickel base alloy. The steel of the protective pipe can likewise comprise an at least part-austenitic microstructure and/or a TRIP and/or TWIP effect and optionally an increased resistance to abrasive wear.

The protective pipe preferably has a full-austenitic microstructure. By an advantageous combination of this protective pipe as an inner pipe with a carrier pipe as the outer pipe made from a TRIP effect alloy the effect of increasing the volume of the outer pipe by the TRIP effect can advantageously be used to connect the outer pipe tightly to the inner pipe.

On the contrary, in the case of an austenitic carrier pipe as the outer pipe and of a single-phase or multi-phase non-fully austenitic protective pipe as the inner pipe the effect of the greater resilience of austenite can be used in such a way that the austenitic carrier pipe with a lower modulus of elasticity than the protective pipe as the inner pipe springs back more strongly after common widening and thereby connects tightly to the inner protective pipe.

Furthermore, a controlled microstructure conversion can advantageously be used in that an austenitic corrosion-resistant protective pipe is placed on or inserted into an austenitic carrier pipe—a multi-phase carrier pipe at room temperature—with a temperature above the Ac1 temperature, which pipe undergoes, during cooling, an at least partial phase conversion from a cubic-surface-centred (austenite) to a cubic-space centred phase (ferrite/martensite/bainite) with a resulting increase in volume. The increase in volume causes the austenitic protective pipe to be tightly pressed.

The inner diameter of the pipe on the outside is in each case slightly greater than the outer diameter of the inner pipe.

In connection with the higher manganese-content steel of the carrier pipe, these protective pipes can be produced using less material and at lower cost than a conventionally produced mechanically plated pipe, wherein the composite pipe achieves extraordinarily good mechanical properties with respect to pressure and bending loads.

In one embodiment the steel of the carrier pipe comprises the following chemical composition (in wt. %): C: 0.005 to 0.9, preferably 0.1 to <0.3; Mn: more than 4.0 to 12, preferably 4 to 8; with the remainder being iron including unavoidable steel-associated elements, with optional addition by alloying of one or more of the following elements (in wt. %): Al: 0 to 10, preferably 0.03 to 0.8; Si: 0 to 6, preferably 0.02 to 0.8; Cr: 0 to 6, preferably 0.05 to 4; Nb: 0 to 1.5, preferably 0.003 to 0.1.; V: 0 to 1.5, preferably 0.006 to 0.1; Ti: 0 to 1.5, preferably 0.002 to 0.5; Mo: 0 to 3, preferably 0.01 to 0.8; Cu: 0 to 3, preferably 0.05 to 2; Sn: 0 to 0.5; W: 0 to 5, preferably 0.03 to 2; Co: 0 to 8, preferably 0.003 to 3; Zr: 0 to 1, preferably 0.03 to 0.5; B: 0 to 0.15, preferably 0.002 to 0.02; P: max. 0.1, in particular <0.04; S: max. 0.1, in particular <0.02; N: max. 0.1, in particular <0.05; Ca to 0.1.

In one embodiment the protective pipe comprises the following chemical composition (in wt. %): C: 0.005 to 0.8; Cr: 7 to 30; with the remainder being iron including unavoidable, steel-associated elements, with optional addition by alloying of the following elements (in wt. %): Ni: 0 to 15; Mn: 0 to 25; Al: 0 to 15; Si: 0 to 8; Mo: 0.01 to 3; Cu: 0.005 to 4; V: 0 to 2; Nb: 0 to 2; Ti: 0 to 2; Sb: 0 to 0.5; B: 0 to 0.5; Co: 0 to 5; W: 0 to 3; Zr: 0 to 4; Ca: 0 to 0.1; P: 0 to 0.6; S: 0 to 0.2; N: 0.002 to 0.3.

In a second embodiment the protective pipe comprises the following chemical composition (in wt. %): Cr: 7 to 20; Mn: 2 to 9; Ni: up to 9; C: 0.005 to 0.4; N: 0.002 to 0.3; with the remainder being iron including unavoidable, steel-associated elements, with optional addition by alloying of the following elements (in wt. %): Al: 0 to 3; Si: 0 to 2; Mo: 0.01 to 3; Cu: 0.005 to 4; V: 0 to 2; Nb: 0 to 2; Ti: 0 to 2; Sb: 0 to 0.5; B: 0 to 0.5; Co: 0 to 5; W: 0 to 3; Zr: 0 to 2; Ca: 0 to 0.1; P: 0 to 0.6; S: 0 to 0.2.

In a third embodiment the protective pipe comprises the following chemical composition (in wt. %): Mn: 5 to 30, C: 0.01 to 0.8, Al: 4 to 10, Cr: 2 to 10, Si: 0 to 3.5, with the remainder being iron including unavoidable, steel-associated elements, with optional addition by alloying of the following elements (in wt. %): Co: 0 to 5; W: 0 to 3, Ca: 0 to 0.1; P: 0 to 0.6; S: 0 to 0.2, Cu: 0.005 to 4, Sb: 0 to 0.5 and optionally in each case up to 1 wt. % of one or more elements from the group of the following elements Zr, Ti, V, Nb, B, Mo, Ni, N, rare earths.

In a fourth embodiment, the protective pipe is made of a nickel-based alloy.

The carrier pipe preferably has a tensile strength of at least 800 MPa and an elongation at fracture of at least 15%.

In accordance with the invention a further method for producing a composite pipe comprised of a carrier pipe and at least one protective pipe using a carrier pipe as described above is created in that the carrier pipe and the at least one protective pipe are mechanically or metallurgically connected to one another. The carrier pipe and the at least one protective pipe are preferably connected to one another mechanically by shrinkage, a reducing ring or common widening, or metallurgically by diffusion annealing, explosive plating or roll plating.

In relation to this, the carrier pipe is preferably formed in the composite with the at least one protective pipe.

Alloy elements are generally added to the steel in order to influence specific properties in a targeted manner. An alloy element can thereby influence different properties in different steels. The effect and interaction generally depend greatly upon the quantity, presence of further alloy elements and the solution state in the material. The correlations are varied and complex. The effect of the alloy elements in the steel of the carrier pipe will be discussed in greater detail hereinafter. The positive effects of the alloy elements used in accordance with the invention will be described hereinafter:

The use of the term “to” in the definition of the content ranges, such as e.g. 5 to 35 wt. %, means that the limit points—5 and 35 in the example—are also included.

Carbon C: is required to form carbides, stabilises the austenite and increases the strength. Higher contents of C impair the welding properties and result in the impairment of the expansion and toughness properties in the steel, for which reason a maximum content of 1.4 wt. % is set. In order to achieve a sufficient strength for the material, a minimum addition of 0.005 wt. % is provided.

Manganese Mn: Mn stabilises the austenite, increases the strength and the toughness and permits a deformation-induced martensite formation and/or twinning in the steel of the carrier pipe. Contents of less than 5 wt. % are insufficient to stabilise the austenite and therefore impair the expansion properties. For the manganese steel of the carrier pipe a range of 5 to 35 wt. % is preferred.

Nickel Ni: Ni stabilises the austenite and improves the expansion properties, in particular at low application temperatures, for which reason a maximum content of 6.0 wt. % is set, wherein a content of 1 to 4 wt. % is preferred.

Chromium Cr: improves the strength and reduces the rate of corrosion, delays the formation of ferrite and perlite and forms carbides. The maximum content is optionally set to 9 wt. % since higher contents result in an impairment of the expansion properties. A content of Cr of 0.5 to 5 wt. % is preferably added by alloying.

Aluminium Al: Al is used to deoxidise steels. Furthermore, an Al content advantageously improves the strength and expansion properties, reduces the relative density and positively influences the conversion behaviour of the alloy in accordance with the invention. Optionally, a maximum content of 15 wt. % is set. A content of Al of 0.5 to 11 wt. % is preferably added by alloying.

Silicon Si: impedes the diffusion of carbon, reduces the relative density and increases the strength and expansion properties and toughness properties. Optionally, a maximum content of 8 wt. %, preferably a content of 0.3 to 5 wt. % is set.

Molybdenum Mo: acts as a strong carbide forming agent and increases the strength. Contents of Mo of more than 3 wt. % impair the expansion properties, for which reason a maximum content of 3 wt. %, preferably a content of 0.01 to 1.8 wt. % is optionally set.

Copper Cu: reduces the rate of corrosion and increases the strength. Contents of above 4 wt. % impair the producibility by forming low-melting phases during casting and hot rolling, for which reason a maximum content of 4 wt. %, preferably a content of 0.005 to 3 wt. % is optionally set.

Typical microalloy elements are vanadium, niobium and titanium. These elements can be dissolved in the iron lattice and form carbides, nitrides and carbonitrides with carbon and nitrogen.

Vanadium V and niobium Nb: these act in a grain-refining manner in particular by forming carbides, whereby at the same time the strength, toughness and expansion properties are improved. Optionally, a maximum content of 2 wt. %, preferably a content of 0.004 to 1 wt. % is set.

Titanium Ti: acts in a grain-refining manner as a carbide forming agent, whereby at the same time the strength, toughness and expansion properties are improved and the inter-crystalline corrosion is reduced. Optionally, a maximum content of 2 wt. %, preferably a content of 0.005 to 1.2 wt. % is set.

Antimony Sb: Antimony reduces the C, N, O and Al diffusion, whereby particularly carbides, nitrides and carbonitrides are more finely precipitated. This improves the effective utilisation of these alloy elements, which increases economic feasibility and reduces the consumption of resources, and improves the strength, expansion and toughness properties. Contents above 0.5 wt. % result in the undesired precipitation of Sb at the grain boundaries and thus results in the impairment of the expansion and toughness properties. Optionally, a maximum content of 0.5 wt. %, preferably a content of 0.003 to 0.2 wt. % is thus set.

Boron B: boron improves the strength and stabilises the austenite. Optionally, a maximum content of 0.5 wt. %, preferably a content of 0.0003 to 0.1 wt. % is set.

Cobalt Co: cobalt increases the strength of the steel, stabilises the austenite and improves the heat resistance. Contents of more than 5 wt. % impair the expansion properties in the alloys in accordance with the invention, for which reason a maximum content of 5 wt. %, preferably a content of 0.01 to 3 wt. % is optionally set.

Tungsten W: tungsten acts as a carbide forming agent and increases the strength and heat resistance. Contents of W of more than 3 wt. % impair the expansion properties, for which reason a maximum content of 3 wt. %, preferably a content of 0.1 to 2 wt. % is optionally set.

Zirconium Zr: zirconium acts as a carbide forming agent and improves the strength. Contents of Zr of more than 4 wt. % impair the expansion properties, for which reason a maximum content of 4 wt. %, preferably a content of 0.005 to 2 wt. % is optionally set.

Calcium Ca: Calcium is used for modifying non-metallic oxidic inclusions which could otherwise result in the undesired failure of the alloy as a result of inclusions in the microstructure which act as stress concentration points and weaken the metal composite. Furthermore, Ca improves the homogeneity of the alloy in accordance with the invention. Contents of above 0.1 wt. % Ca do not provide any further advantage in the modification of inclusions, impair producibility and should be avoided by reason of the high vapour pressure of Ca in steel melts. Thus, a maximum content is optionally set to 0.1 wt. %.

Phosphorus P: is a trace element from the iron ore and is dissolved in the iron lattice as a substitution atom. Phosphorous increases the hardness and improves the hardenability by means of mixed crystal solidification. However, attempts are generally made to lower the phosphorous content as much as possible because inter alia it exhibits a strong tendency towards segregation owing to its low diffusion rate and greatly reduces the level of toughness. The attachment of phosphorous to the grain boundaries can cause cracks along the grain boundaries during hot rolling. Moreover, phosphorous increases the transition temperature from tough to brittle behaviour by up to 300 K. For the aforementioned reasons, the phosphorous content is optionally limited to less than or equal to 0.6 wt. %, preferably from 0.0005 to 0.1 wt. %.

Sulphur S: like phosphorous, is bound as a trace element in the iron ore. It is generally not desirable in steel because it exhibits a strong tendency towards segregation and has a greatly embrittling effect. Furthermore, sulphur forms manganese sulphide (MnS) with manganese, which manganese sulphide is present in lines in the microstructure after rolling and in particular impairs the expansion and toughness properties. An attempt is therefore made to achieve amounts of sulphur in the melt which are as low as possible (e.g. by deep vacuum treatment). For the aforementioned reasons, the sulphur content is optionally limited to less than or equal to 0.2 wt. %.

Nitrogen N; N is likewise an associated element from steel production. In the dissolved state, it improves the strength and toughness properties in steels containing a higher content of manganese of greater than or equal to 5 wt. % Mn. Binding of the nitrogen in the form of nitrides is possible by adding e.g. aluminium, vanadium, niobium or titanium by alloying. For the aforementioned reasons, the nitrogen content is optionally limited to less than or equal to 0.3 wt. %, preferably to 0.004 to 0.2 wt. %.

A composite pipe 1 in accordance with the invention will be explained in greater detail hereinafter with reference to a drawing. In the Figures:

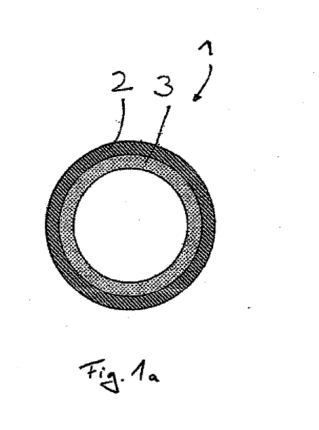

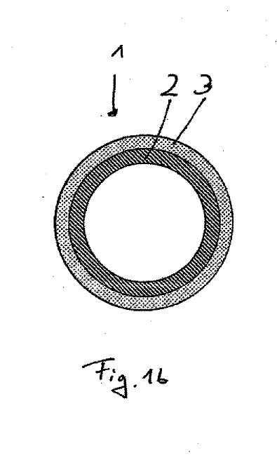

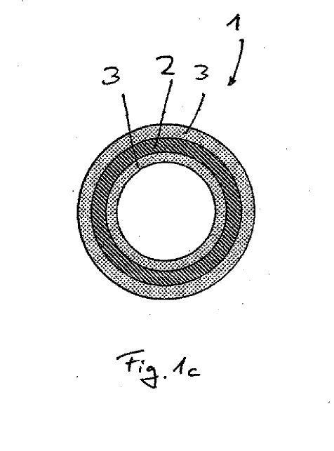

FIG. 1a is a cross-sectional view of a first embodiment of a composite pipe 1,

FIG. 1b is a cross-sectional view of a second embodiment of a composite pipe 1, and

FIG. 1c is a cross-sectional view of a third embodiment of a composite pipe 1.

A composite pipe 1 produced in accordance with the invention includes, according to FIGS. 1a to 1c, of a carrier pipe 2 and at least one protective pipe 3 mechanically connected thereto. The protective pipe 3 can be on the inside (see FIG. 1a) or outside (see FIG. 1b). A combination with a protective pipe 3 inside and outside (see FIG. 1c) is also possible. The carrier pipe 2 is made, as described above, a higher manganese-content, non-corrosion-resistant steel; the protective pipe 3 is made of a corrosion-resistant or corrosion-passive steel. The inner and outer protective pipe 3 can also be made of different materials. In the composite pipe 1 of FIG. 1a a corrosive medium can be transported inside the protective pipe 3 of the composite pipe 1. In relation to this, the protective pipe 3 is advantageously formed in such a way that its thickness results only from the requirement of being corrosion-resistant. The carrier pipe 2 can be formed by the use of a higher manganese-content steel with a clearly reduced wall thickness and also ensures a high level of pressure and bending resistance compared to a conventional carrier pipe 2 made of carbon steel. In addition, by increasing the wall thicknesses of the high manganese-content carrier pipes 2 clearly higher levels of pressure resistance can also be achieved compared with carbon steel-based carrier pipes 2. Using the composite pipe 1 of FIG. 1b non-aggressive or non-corrosive media can be conveyed within an aggressive or corrosive external: environment.

Instead of a second protective pipe 3 on the outside or inside, the composite pipe 1 formed from the carrier pipe 2 and protective pipe 3 can also be provided with an active and/or passive anti-corrosion layer, e.g. in the form of a metallic coating (e.g. zinc, zinc alloy, nickel or chromium layer) or an alternative organic or inorganic coating or lacquer. The connection of individual pipe ends of the composite pipes 1 to one another can be effected by different means or methods such as e.g. welding, laser welding, resistance welding, gluing, clinching, flanges or screw sockets.

The carrier pipe 2 is metallurgically or mechanically connected to the protective pipe or pipes 3 in a known manner. Metallurgical connecting methods include e.g. co-extrusion, roll plating, hot isostatic pressing, explosive plating or weld plating. As a method for mechanical connection, e.g. in relation to an embodiment with an inner protective pipe 3, hydraulic widening of the protective pipe 3, with or without simultaneous heating of the carrier pipe 2, widening of the protective pipe 3 with a drawing plug, or reducing the carrier pipe 2 by means of a drawing ring are to be considered. Prior to the mechanical connection the carrier pipe 2 and the protective pipe 3 or the protective pipes 3 are pushed one inside the other. In relation to this, the inner protective pipe 3 has a slightly smaller outer diameter than the inner diameter of the carrier pipe 2 or the outer protective pipe 3 has a slightly larger inner diameter than the outer diameter of the carrier pipe 2. In relation to this, the protective pipe 3 and the carrier pipe 2 can be seamless, welded on a longitudinal seam or welded on a spiral seam.

The invention is described above in relation to composite pipes 1 with a round cross-section. It is obvious that this invention also applies to the case of composite pipes 1 with any cross-section (e.g. rectangular, elliptical or having a cross-section that changes over the pipe length) and pipes for internal high-pressure forming (IHPF).

The pipe produced in accordance with the invention can be used in areas with corrosive and/or abrasive environmental conditions or to convey and transport corrosive and/or abrasive media. It can be used in particular in the following areas: plant construction (e.g. chemical or pharmaceutical plants), food technology, boiler construction (e.g. pressure vessels and heat storage boilers), conveying technology (e.g. oil and gas supply, conveying of other media), pipeline construction (e.g. oil and gas pipelines), lower temperature application (e.g. gas liquefaction, liquid gas transport, as casing material for (high-temperature) supraconductors, cryotechnology), vehicle construction (e.g. utility vehicles, yellow goods), IHPF applications (e.g. automobile construction, plant construction).

### LIST OF REFERENCE SIGNS

1 composite pipe
2 carrier pipe
3 protective pipe

What is claimed is:

1.-30. (canceled)

31. A composite pipe, comprising:
a carrier pipe; and
at least one protective pipe,
said carrier pipe being produced from a non-corrosion-resistant steel which comprises at least one part-austenitic microstructure, having the following chemical composition (in wt. %):
C: 0.005 to 1.4
Mn: 5 to 35
with the remainder being iron including unavoidable, steel-associated elements, with optional addition by alloying of the following elements (in wt. %):
Ni: 0 to 6
Cr: 0 to 9
Al: 0 to 15
Si: 0 to 8
Mo: 0 to 3
Cu: 0 to 4
V: 0 to 2
Nb: 0 to 2
Ti: 0 to 2
Sb: 0 to 0.5
B: 0 to 0.5
Co: 0 to 5
W: 0 to 3
Zr: 0 to 4
Ca: 0 to 0.1
P: 0 to 0.6
S: 0 to 0.2
N: 0.002 to 0.3.

32. The composite pipe of claim 31, wherein the steel of the carrier pipe contains (in wt. %): Ni: 1 to 4.

33. The composite pipe of claim 31, wherein the steel of the carrier pipe contains (in wt. %): Cr: 0.5 to 5.

34. The composite pipe of claim 31, wherein the steel of the carrier pipe contains (in wt. %): Al: 0.5 to 11.

35. The composite pipe of claim 31, wherein the steel of the carrier pipe contains (in wt. %): Si: 0.3 to 5.

36. The composite pipe of claim 31, wherein the steel of the carrier pipe contains (in wt. %): Mo: 0.01 to 1.8.

37. The composite pipe of claim 31, wherein the steel of the carrier pipe contains (in wt. %): Cu: 0.005 to 3.

38. The composite pipe of claim 31, wherein the steel of the carrier pipe contains (in wt. %): V: 0.004 to 1.

39. The composite pipe of claim 31, wherein the steel of the carrier pipe contains (in wt. %): Nb: 0.004 to 1.

40. The composite pipe of claim 31, wherein the steel of the carrier pipe contains (in wt. %): Ti: 0.005 to 1.2.

41. The composite pipe of claim 31, wherein that the steel of the carrier pipe contains (in wt. %): Sb: 0.003 to 0.2.

42. The composite pipe of claim 31, wherein the steel contains (in wt. %): B: 0. 0003 to 0.1.

43. The composite pipe of claim 31, wherein the steel of the carrier pipe contains (in wt. %): Co: 0.01 to 3.

44. The composite pipe of claim 31, wherein the steel of the carrier pipe contains (in wt. %): W: 0.1 to 2.

45. The composite pipe of claim 31, wherein the steel of the carrier pipe contains (in wt. %): Zr: 0.005 to 2.

46. The composite pipe of claim 31, wherein the steel of the carrier pipe contains (in wt. %): P: 0.0005 to 0.1.

47. The composite pipe of claim 31, wherein the steel of the carrier pipe contains (in wt. %): N: 0.004 to 0.2.

48. The composite pipe of claim 31, wherein the steel of the carrier pipe contains (in wt. %):
C: 0.005 to 0.9, preferably 0.01 to <0.3
Mn: more than 4.0 to 12, preferably 4 to 8
with the remainder being iron including unavoidable steel-associated elements, with optional addition by alloying of one or more of the following elements (in wt. %):
Al: 0 to 10, preferably 0.03 to 0.8
Si: 0 to 6, preferably 0.02 to 0.8
Cr: 0 to 6, preferably 0.05 to 4
Nb: 0 to 1.5, preferably 0.003 to 0.1
V: 0 to 1.5, preferably 0.006 to 0.1
Ti: 0 to 1.5, preferably 0.002 to 0.5
Mo: 0 to 3, preferably 0.01 to 0.8
Cu: 0 to 3, preferably 0.05 to 2
Sn: 0 to 0.5
W: 0 to 5, preferably 0.03 to 2
Co: 0 to 8, preferably 0.003 to 3
Zr: 0 to 1, preferably 0.03 to 0.5
B: 0 to 0.15, preferably 0.002 to 0.02
P: max. 0.1, in particular <0.04
S: max. 0.1, in particular <0.02
N: max. 0.1, in particular <0.05
Ca: to 0.1.

49. The composite pipe of claim 31, wherein the carrier pipe has a tensile strength of at least 800 MPa and an elongation at fracture of at least 15%.

50. The composite pipe of claim 31, wherein the carrier pipe is produced from a steel which has a TRIP and/or TWIP effect under the effect of mechanical stresses.

51. The composite pipe of claim 31, wherein the carrier pipe is produced from a steel which has a microstructure with an austenite content of 5 to 100%.

52. The composite pipe of claim 31, wherein the at least one protective pipe is produced from a corrosion-resistant or corrosion-passive steel.

53. The composite pipe of claim 31, wherein the at least one protective pipe has at least a part-austenitic microstructure and has, a TRIP and/or TWIP effect under the effect of mechanical stresses.

54. The composite pipe of claim 31, wherein the at least one protective pipe has a full-austenitic microstructure.

55. The composite pipe of claim 31, wherein the protective pipe is produced from a corrosion-resistant or corrosion-passive steel having the following chemical composition (in wt. %):
C: 0.005 to 0.8
Cr: 7 to 30
with the remainder being iron including unavoidable, steel-associated elements, with optional addition by alloying of the following elements (in wt. %):
Ni: 0 to 15
Mn: 0 to 25
Al: 0 to 15
Si: 0 to 8
Mo: 0.01 to 3
Cu: 0.005 to 4
V: 0 to 2
Nb: 0 to 2
Ti: 0 to 2
Sb: 0 to 0.5
B: 0 to 0.5
Co: 0 to 5
W: 0 to 3
Zr: 0 to 4
Ca: 0 to 0.1
P: 0 to 0.6
S: 0 to 0.2
N: 0.002 to 0.3.

56. The composite pipe of claim 31, wherein the protective pipe is produced from a corrosion-resistant or corrosion-passive steel having the following chemical composition (in wt. %):
Cr: 7 to 20
Mn: 2 to 9
Ni: up to 9
C: 0.005 to 0.4
N: 0.002 to 0.3
with the remainder being iron including unavoidable, steel-associated elements, with optional addition by alloying of the following elements (in wt. %):
Al: 0 to 3
Si: 0 to 2
Mo: 0.01 to 3
Cu: 0.005 to 4
V: 0 to 2
Nb: 0 to 2
Ti: 0 to 2
Sb: 0 to 0.5
B: 0 to 0.5
Co: 0 to 5
W: 0 to 3
Zr: 0 to 2
Ca: 0 to 0.1
P: 0 to 0.6
S: 0 to 0.2.

57. The composite pipe of claim 31, wherein the protective pipe is produced from a corrosion-resistant or corrosion-passive steel having the following chemical composition (in wt. %):
Mn: 5 to 30%
C: 0.01 to 0.8%
Al: 4 to 10%
Cr: 2 to 10%
Si: 0 to 3.5%
with the remainder being iron including unavoidable, steel-associated elements, with optional addition by alloying of the following elements (in wt. %):
Co: 0 to 5
W: 0 to 3
Ca: 0 to 0.1
P: 0 to 0.6
S: 0 to 0.2
Cu: 0.005 to 4
Sb: 0 to 0.5
and optionally in each case up to 1 wt. % of one or more elements from the group of the following elements: Zr, Ti, V, Nb, B, Mo, Ni, N, rare earths.

58. The composite pipe of claim 31, wherein the protective pipe is produced from a corrosion-resistant or corrosion-passive nickel-based alloy.

59. A method for producing a composite pipe comprised of a carrier pipe and at least one protective pipe, said carrier pipe being produced from a non-corrosion-resistant steel which comprises at least one part-austenitic microstructure, having the following chemical composition (in wt. %):
C: 0.005 to 1.4
Mn: 5 to 35
with the remainder being iron including unavoidable, steel-associated elements, with optional addition by alloying of the following elements (in wt. %):
Ni: 0 to 6
Cr: 0 to 9
Al: 0 to 15
Si: 0 to 8
Mo: 0 to 3
Cu: 0 to 4
V: 0 to 2
Nb: 0 to 2
Ti: 0 to 2
Sb: 0 to 0.5
B: 0 to 0.5
Co: 0 to 5
W: 0 to 3
Zr: 0 to 4
Ca: 0 to 0.1
P: 0 to 0.6
S: 0 to 0.2
N: 0.002 to 0.3,
said method comprising mechanically or metallurgically connecting the carrier pipe and the at least one protective pipe to one another.

60. The method of claim 59, wherein the carrier pipe is formed in the composite with the at least one protective pipe by internal high-pressure forming.
